(19) United States
(12) Patent Application Publication
(10) Pub. No.: US 2006/0020542 A1
(43) Pub. Date: Jan. 26, 2006

(54) Method and system for processing financial transactions

(76) Inventors: Thomas J. Litle, Concord, MA (US); Palle M. Pedersen, Belmont, MA (US); Ashesh C. Shah, Brookline, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/896,518

(22) Filed: Jul. 21, 2004

(51) Int. Cl. G06Q 99/00

(52) U.S. Cl. 705/40; 705/1

(57) ABSTRACT

A method and system for processing financial transactions by receiving a payment transaction as an Issuing Payment Processor, converting the payment into one or more derivative transactions based on a defined rules set, and then sending, as a Merchant Payment Processor, the resulting derivative transaction or transactions to another Issuing Payment Processor, resulting in real-time settlement, faster and less costly implementation of discount, gift, and loyalty programs, and enhanced member credit card security and privacy.

### BACKGROUND OF THE INVENTION

Financial credit transactions are typically performed electronically using a Standard Payment Network (SPN) such as the VISA or MASTERCARD financial data network to enable credit cardholders to conveniently purchase goods and services without the need to directly handle money. As a substitute for cash, creditors or banks issue credit cards to cardholders which are presented to merchants during the purchase of goods or services. Each credit card contains a unique credit card number, also known as the Payment System Identifier (PSID), that is bound to the credit account of each cardholder. In the VISA financial network, the PSID is 16 digits in length as shown by the exemplary format “5123 5555 5555 1234.” The first four digits, e.g., 5123, comprise the Bank Identification Number (BIN) which identifies the cardholder's credit source and enables the SPN to electronically route associated payment transactions to the cardholder's credit source.

Instead of presenting cash, a cardholder presents the credit card and/or PSID to a merchant, effectively authorizing the electronic transfer of funds, equal to the purchase amount, from the cardholder's credit or bank account to the participating merchant. Merchants typically use a Point-of-Sale (POS) terminal to retrieve a credit card's PSID, which is embedded on the card's magnetic strip, by swiping the card through their POS terminal reader. Merchants also enter the purchase amount of a payment transaction into the POS terminal which then sends the payment transaction information, or Transaction Package (TP), through the Merchant's Payment Processor (MPP) to the SPN. The MPP is a computer server that 1) accepts electronic payment transactions originating from merchant POS terminals and payment gateways and 2) sends those transactions to the SPN. One MPP may interface with many POS terminals associated with many different merchants at different locations. Many MPPs may be connected to and interface with the SPN. MPPs only send credit or debit transactions originating from the credit cardholder's merchant to Issuing Payment Processors (IPP).

An IPP is a computer server that 1) accepts electronic payment transactions from an MPP and 2) sends those transactions to a particular credit source. One IPP may interface with many credit sources. Many IPPs may connect to and interface with the SPN. Both MPPs and IPPs are connected to the SPN through addressable access points to enable the SPN to route payment transactions to and from the proper MPP or IPP.

FIG. 1 illustrates the typical financial transaction system utilizing an SPN, such as the VISA financial data network, wherein credit card 12 is used to purchase goods and services from merchant 14 using the following process. Credit card issuing credit source 16, i.e., a bank, issues credit card 12, which contains a unique PSID, to a cardholder. When the cardholder presents the PSID associated with credit card 12 to merchant 14 in order to purchase goods using credit provided by credit source 16, merchant 14 submits the associated payment transaction to MPP 18. MPP 18 clears the payment transaction with the acquiring bank of merchant 14. MPP 18 then submits the payment transaction to SPN 20 through access point 22. Additional access points 28 provide connectivity for additional MPPs or IPPs to SPN 20.

The payment transaction or TP includes at least the purchase amount, merchant 14 identifier, an access point 22 identifier, name of the cardholder, PSID, expiration date, credit card verification number (CVV), transaction number, and location of the purchase. SPN 20 is exemplary of the VISA/Mastercard financial transaction network that uses a ring topology to route payment transactions. SPN 20 routes the payment transaction, based on the four digit BIN within the PSID, to access point 24 associated with credit source 16 and IPP 26.

After IPP 26 receives the payment transaction from access point 24, IPP 26 verifies with credit source 16 that the payment transaction is valid. If the credit cardholder has a valid account with sufficient funds, credit source 16 sends an approval code back to IPP 26 and places a hold on the amount of funds or credit associated with the payment transaction within the cardholder's account. Once an approval or authorization code is received from credit source 16, IPP 26 returns the payment transaction via access points 24 and 22 to MPP 18 with the approval code. MPP 18 then returns the transaction approval code to merchant 14 who presents an associated sales receipt to the cardholder for the cardholder's signature. Once signed, the cardholder purchase of goods or services from merchant 14 is complete.

In order to acquire the cardholder's funds that were authorized by credit source 16, merchant 14 subsequently performs a capture and settlement of the authorized payment transaction by sending a payment transaction “capture” request including the approval code, merchant 14 identifier, and transaction number to credit source 16 via MPP 18, access points 22 and 24, and IPP 26. Once received, credit source 16 verifies the approval code associated with the payment transaction and transfers the cardholder funds that were originally placed on hold to merchant account 192 via IPP 26, access points 24 and 22, and MPP 18. Merchant account 192 is a business account, sanctioned by an acquiring bank, but managed by MPP 18 with the ability to receive electronic payment transactions from SPN 20. The funds that accumulate in merchant account 192 are periodically transferred into a standard bank account of merchant 14. Merchant 14 also periodically initiates capture and settlement as a batch process, usually every 24-72 hours, to settle many payment transactions at the same time.

Promotional discounts associated with credit card payments are usually tracked using unique promotional codes entered into the merchant's purchase and sales system by an employee. Alternatively, registered credit card discounts that rely on data mining at the MPP eliminate the need for merchants and their employees to track promotional codes. When a credit card is registered, the card registrar purchases the transaction records collected by certain MPPs for a period of time and then searches the collected or aggregated databases for registered credit card PSIDs. If a registered PSID is found, the registrar applies the discount or virtual coupon credit to the registered credit card account. Data mining, however, is not performed in real-time and not performed with all MPPs.

### BRIEF SUMMARY OF THE INVENTION

A method and system of processing financial transactions on a financial network that relies on an enhanced server. In one form, the enhanced server is an intermediate server with the ability to receive a payment transaction as an Issuing Payment Processor, convert the payment transaction into one or more derivative transactions, and then send the derivative transaction or transactions, as a Merchant Payment Processor, to other Issuing Payment Processors. In certain implementations, each payment transaction may be converted, based on a defined rules set, into a dynamically determined derivative transaction or multiple derivative transactions. Furthermore, one or more additional derivative transactions may be bridged to another payment processing network or be a trigger for a non-financial action.

A derivative transaction may be used to acquire monetary value derived from either a virtual coupon, gift card, or promotional discount. Also, a merchant promotional bounty may be shared among a sponsor, member, and the intermediate server. All processing is typically performed by one or more general purpose computer systems.

The defined rules may be based on the member card issuer, credit card issuer, member, merchant, and network preference which specify limitations on the creation of derivative transactions based on date, time, purchase amount, purchase type, or location. Furthermore, the preferences of one rules set input entity can be assigned higher priority over the preferences of other input entities. In certain embodiments, the defined rules set is typically predetermined.

In another embodiment, a method of processing payments and promotional bounties using a payment processing network includes having a sponsor establish a rules set regarding acceptance and use of a member identity token. The sponsor then recruits participating merchants who establish a bounty for any valid transaction using a member payment system identifier associated with the sponsor. The bounty is the amount of money a merchant pays to acquire a particular customer purchase and may include the purchase discount, a sponsor fee, and an intermediate server handling fee. The sponsor typically defines the portions of the bounty within the rules set to be shared between the sponsor, member, and the intermediate server.

A merchant establishes a promotional fund source and specifies the member discount associated with goods subject to the discount. The sponsor issues a member identity token, e.g., member credit card, associated with a unique member PSID. The member then registers the PSID associated with the sponsor and one or more other PSIDs, each associated with a credit source, with the intermediate server that activates the member.

To purchase goods and potentially receive enhanced services, the member presents the PSID associated with the sponsor to the merchant who submits the payment transaction, including member PSID associated with the sponsor, to the merchant's MPP for approval and settlement. The MPP then directs the payment transaction to the appropriate payment network based on the BIN for approval and settlement.

The same intermediate server, acting as an IPP, receives the payment transaction. Based on the defined rules set, the intermediate server evaluates and converts the payment transaction into multiple derivative transactions. Then, the intermediate server, acting as a MPP, sends one or more of the following derivative transactions: a collection transaction to the member's credit source for the amount associated with the purchased goods less any discount specified in defined rules set, a collection transaction to the merchant promotional fund source for the bounty amount, a credit transaction to the merchant's account for the amount associated with the purchased goods, a credit transaction to the sponsor in an amount equal to the portion of the bounty as defined by the sponsor within the rules set, and a credit transaction to the intermediate server in an amount equal to the portion of bounty as defined by the sponsor within the rules set. The credit source also sends an approval code to the intermediate server that is relayed to the merchant.

The member identity token is typically a credit card using a member 15 or 16 digit PSID, but may also be a smart card, cellular telephone, pager or personal digital assistant (PDA) with a member PSID. A credit source is a usually a standard, gift, or promotional bank account. The member account may be activated when the member identity information is stored within the intermediate server.

The intermediate server may reside on a data network using a ring topology. All transactions typically occur in real-time or near real-time. Alternatively, a credit source may be another merchant while the secondary promotional fund source is typically a bank account.

The intermediate server, based on the rules set, may increase the derivative credit transaction value according to the value of a virtual coupon, gift card, or promotional voucher. Also, the intermediate server may collect non-monetary value from a merchant, convert the non-monetary value to a monetary equivalent based on the rules set, and use the resulting monetary value in derivative credit transactions. Such non-monetary value may be an amount of frequently flyer points.

In another embodiment, a method of processing financial transactions with enhanced privacy and security involves receiving payment transaction information and a request for a Generated Identification Number (GIN) from a member on a secure network. Once the request is received, a GIN is created, associated with the payment transaction and a credit source of the member, and sent to the member. Then, acting as an Issuing Payment Processor on a financial network, the payment transaction associated with the GIN is received. The GIN and payment transaction information received from the financial network are verified and correlated with the GIN generated and transaction information received from the secure network. The payment transaction is converted into a derivative transaction and, acting as a Merchant Payment Processor, is sent to another Issuing Payment Processor.

The GIN may be a one-time PSID. Furthermore, a member personal identification number (PIN) or secret may be included in the GIN or with the payment transaction information received from the secure network. At least a portion of the GIN may be randomly or pseudo-randomly generated or derived based on a combination of a BIN, date and time stamp of transaction initiation swipe, a terminal identification number, PSID, and a checksum. The GIN may be encoded with additional feature or authorization codes and include a BIN.

The secure network may be a virtual private network (VPN) within an insecure network and the processing may be performed by a general purpose computer server or multiple general purpose computer servers. Furthermore, the secure network may use an encrypted and authenticated tunnel based on a shared secret between a member POS terminal and a general purpose computer server. The POS terminal may have the form factor of and may be inserted as a floppy disk or universal serial bus (USB) device into a personal computer.

The various embodiments of the present invention address numerous disadvantages of existing financial credit transaction systems that are discussed in further detail as follows.

While existing financial transaction systems require consumers to hold multiple credit cards in order to use credit from multiple sources, certain embodiments of the present invention provide an improved method and system for processing financial transactions wherein the capabilities of an IPP and MPP are combined to enable a credit card user to associate multiple credit cards and credit card PSIDs to one member token, e.g., credit card, using a member PSID. This enables the credit cardholder to carry one member token or card while eliminating the need to carry multiple credit cards.

When a credit card user presents their conventional credit card to a merchant to initiate a purchase, the merchant or associated MPP can capture and collect user purchase information and possibly sell such information to other credit or marketing organizations, further compromising the user's privacy. Certain embodiments, however, provide enhanced credit card privacy because the merchant and MPP cannot observe and track the member's credit card PSIDs, preventing the collection and distribution of the member's private purchase information to any other party.

Currently, merchants have limited ability to track or support promotional discounts, virtual coupons, and gift card credits because financial transaction networks do not inherently support such tracking which requires additional systems and processing. Also, even if such support is added at additional cost, merchant employees and clerks must be aware of and trained to enter the proper promotional codes to provide the credit to a purchaser and facilitate the promotional tracking.

Certain embodiments provide a method and system which enables merchants to track and support promotional discounts, virtual coupons, and gift card credits at minimal additional cost to merchants by eliminating the need to implement addition supporting systems and by eliminating the need for merchant employees to be aware of or trained to enter particular promotional codes into the merchant's purchase and sales system.

As discussed previously, registered credit cards enable cardholders to receive discounts without requiring an merchant employee to enter a promotional code. Unfortunately, because the discount may be applied days or weeks after the actual purchase, the credit cardholder or merchant may not be able to associate the discount to the product, service, or vendor that was originally promoted by the discount, resulting in loss of vendor brand recognition by the cardholder and, more importantly, merchant.

Certain embodiments provide real-time settlement of promotional discounts, virtual coupons, and gift card credits and, thereby, preserve any brand recognition associated with the product or service discount. Unlike current registered credit card systems where payment transactions must be collected from a MPP and searched for the registered PSID, the present embodiments provide a method and system in which derivative transactions are created in real-time to facilitate an immediate and recognized discount for the member and real-time collection of the contributions by the merchant to the sponsor.

A problem with current financial transaction systems is that if a gift card or virtual coupon is not redeemed or used within a reasonable period of time, the merchant coupon or gift card provider may be obligated by state law for a statutory period of years to possibly redeem the coupon. For example, Massachusetts currently requires that a gift card be valid and redeemable for up to seven years from the gift card's issue date. If there is no explicitly posted expiration date associated with the coupon or gift card, such coupon may be redeemable in perpetuity. These statutory requirements and escheat laws place a significant administrative burden on the coupon or gift card provider to account for the potential financial liability of lost or destroyed gift cards or coupons for many years beyond the issue date.

Because certain embodiments allow the gift card or coupon provider to track redemptions in real-time, the provider can more efficiently and cost effectively manage gifts and coupons and account for possible future liabilities over the statutory redemption period. Furthermore, certain embodiments automatically apply a virtual coupon or allow a member to redeem even a lost coupon or gift card, thereby, further reducing the burden of accounting for lost gift cards or coupons that are subject to statutory redemption requirements.

Certain gift cards may only be supported by certain merchant payment gateways or MPPs because current gift card or virtual coupon processing is logically and/or physically located at the MPP. Thus, a gift card that works with one merchant or group of merchants that use a certain MPP or set of MPPs may not be supported by another merchant or group of merchants that use different MPPs, at least until costly processing is added to the later MPPs to support the gift cards or virtual coupons.

Certain embodiments provide a method and system which allows any gift card or coupon from a merchant associated with a particular MPP to be used by another merchant associated with a different MPP. Furthermore, if a merchant has multiple POS terminals associated with different merchant gateways and MPPs, these embodiments allow the same gift card or coupon to be used at all POS terminals. No additional processing or systems are needed at the MPPs or merchant gateways and, thus, the cost of supporting gift cards or coupons from multiple locations is significantly reduced.

On-line credit card fraud has been a significant problem for current financial transaction systems. Current on-line purchases are usually protected by a user's web browser using strong Secure Socket Layer (SSL) authentication and encryption. Most on-line purchasers, however, have little understanding of how SSL encryption works or when it may or may not be functioning, which inhibits their confidence that their credit card PSIDs will not be compromised. Such security will not protect the credit card PSID if the merchant credit card database is compromised by hackers. Also, a credit cardholders may be tricked by false advertisements, promotions, or other schemes into revealing their credit card PSIDs to criminals. Unfortunately, once the PSID is exposed to criminals, resulting in potentially damaging charges to the user's credit history, the credit cardholder must be issued a new credit card with a new PSID.

Certain embodiments protect a member's credit card PSID from disclosure to hackers or criminals when performing on-line financial payment transactions by providing the member with a one-time generated identification number (GIN), i.e., one-time PSID, which is only valid for one particular purchase and then worthless to criminals or hackers subsequently. The member's credit card PSIDs are never exposed to criminals, preventing possible fraudulent purchases using the member's credit cards and potential damage to the member's credit history.

Whenever a credit card purchase occurs on a financial transaction network, the network operator, e.g., VISA, collects a percentage of the purchase, known as the interchange rate. Certain transactions, where the credit card can be physically verified by the merchant to be in the user's presence or where the user enters a valid Personal Identification Number (PIN), are defined as Card Present (CP) transactions. On-line credit card purchases, where the card cannot physically be verified, are defined as Card-Not-Present (CNP) transactions. The VISA financial network interchange rate for CP transactions is approximately 1.5%, while the CNP transaction rate is as high as 3.5% due to the increased fraud risk of on-line transactions where the card cannot be verified to be in the cardholder's presence. This significantly higher CNP interchange rate results in increased cost to the on-line merchant and, indirectly, to the credit cardholder who pays more for the same product to cover the increased interchange rate.

Certain embodiments enable a merchant and member to convert a CNP transaction into a CP transaction using a one-time GIN and, thereby, reduce the interchange rate charged by the payment network operator for a particular transaction by up to two hundred basis points. Reduction of the interchange rate from 3.5% to 1.5% results in significant savings directly to the merchant and indirectly to the member.

While current financial transaction systems may support the accumulation of non-monetary benefits such as frequent flyer points based on the amount of monetary purchases associated with a certain credit card, there is no convenient method of converting non-monetary value, such as frequently flyer points, from one merchant in real-time into a possible credit or discount toward a purchase from the same or another merchant. Certain embodiments, however, provide a method and system wherein an intermediate server conveniently, automatically, and immediately converts non-monetary value, from any merchant, such as frequent flyer or other loyalty program points into an equivalent monetary value. Thus, any non-monetary value source may be used as an additional credit source for a member during a purchase of goods or services.

Not all financial transaction networks function the same. Thus, an American Express credit card only utilizes the American Express data network while a VISA or Mastercard only utilizes the VISA/Mastercard financial data network. Also, a regional financial network, such as in China, may not support VISA, Mastercard or American Express transactions. Conversely, credit cards used within China's financial transaction network are not currently supported by other financial networks such as VISA.

Certain embodiments, however, provide a method and system that facilitates financial payment transactions between unlike payment transaction networks. In other words, the present embodiments provide a bridge between different financial transaction networks whereby a credit card user from one network, e.g., China payment network, is assigned a member token and PSID to be used in the current VISA/Mastercard financial network. Payment transactions within the VISA network may be routed to China's payment network using a bridging intermediate server that virtually expands the consumer base for merchants using the VISA financial transaction network.

While current financial transaction networks utilize methods that check for fraud and limit certain actions such as credit card purchases that exceed a defined limit, there is no centralized or unified rules-based control to enable a credit cardholder and credit card issuer to automatically designate which credit card and/or credit source to use. Furthermore, there is no mechanism or rules set to dynamically trigger certain actions or multiple actions when the credit cardholder initiates a particular type of transaction.

Certain embodiments, however, provide a credit cardholder and/or member, credit card issuer, member issuer, network, and merchants with a centralized method to define, based on a rules set, which credit sources a member will use for certain types of purchases. These embodiments also provide a mechanism to dynamically trigger certain actions, such as opening a member's garage door or sending a pager alert when certain transactions are initiated.

There is no cost effective or convenient method within current financial transaction networks to establish a real-time promotional discount for certain designated credit card users, e.g., AARP members, whereby merchants can in real-time credit the credit cardholder's account with virtual coupons or discounts, merchants can pay a bounty, i.e., customer acquisition fee, to the sponsoring association, e.g., AARP, and merchants can track the promotional discounts used.

Certain embodiments provide a method and system that, with minimal implementation cost to the merchant, support real-time promotional discounts to certain designated members of a sponsor association. These embodiments also provide real-time settlement between the merchant and sponsor wherein the merchant pays a bounty for each purchase promoted by the sponsor.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a prior art financial transaction network;

FIG. 2 is a schematic diagram illustrating a financial transaction network using the intermediate server;

FIG. 3 is a flow chart of a procedure for processing financial transactions;

FIG. 4 is a schematic diagram illustrating the bridging capability of the intermediate server;

FIG. 5 is a flow chart of a procedure for processing financial transactions based on a defined rules set;

FIG. 6 is a flow chart of a procedure for processing financial transactions based on a defined rules set;

FIG. 7 is a diagram showing an exemplary decision rules set;

FIG. 8 is a schematic diagram illustrating a financial transaction network using the intermediate server with enhanced privacy and security;

FIG. 9 shows the generated identification number (GIN) format;

FIG. 10 shows the generated identification number (GIN) format with PIN included;

FIG. 11 is a flow chart of a procedure for processing financial transactions with enhanced privacy and security;

FIG. 12 is a schematic diagram illustrating a financial transaction network providing promotional bounties;

FIGS. 13A, B, and C provide a flow chart of a procedure for processing financial transactions that utilize a promotional bounty;

FIG. 14 is a functional block diagram of a payment transaction processing system on a financial network; and

FIG. 15 is a functional block diagram of a general purpose computer.

### DETAILED DESCRIPTION OF THE INVENTION

A description of preferred embodiments of the invention follows.

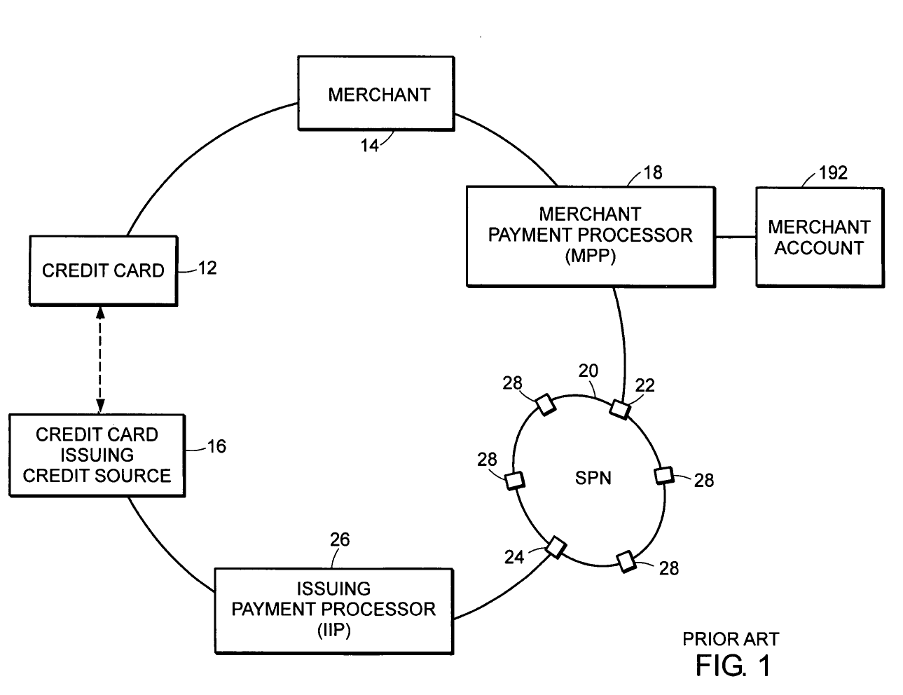

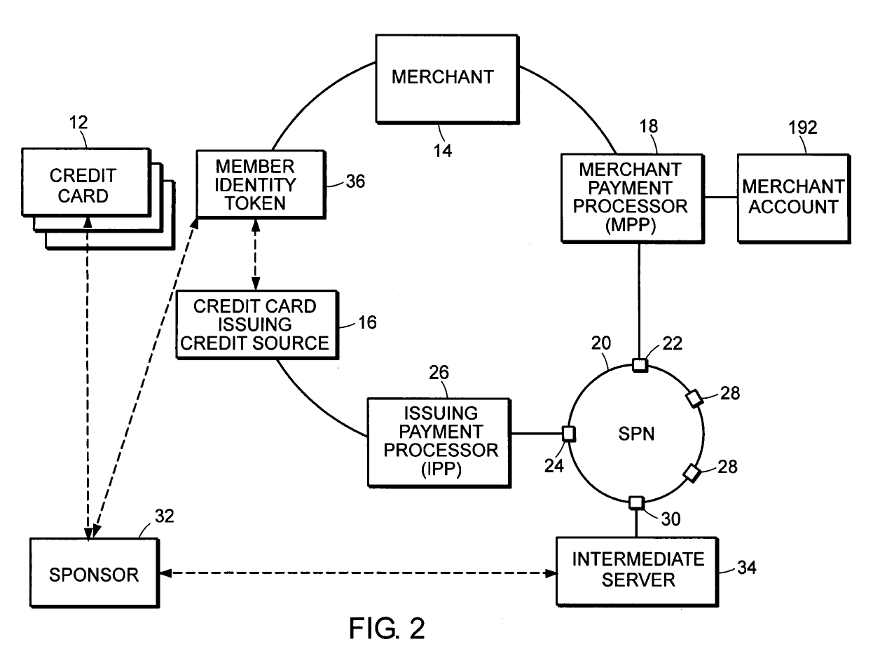

In one embodiment, the FIG. 2 financial transaction network includes network elements that are defined and function equivalently to the essential elements discussed in existing FIG. 1 network such as credit card 12, credit card issuing credit source 16, merchant 14, MPP 18 and associated access point 22, IPP 26 and associated access point 24, and merchant account 192. To provide enhanced financial transaction capabilities, intermediate server 34, associated access point 30, sponsor 32, and member identity token 36 are included in the financial transaction network of FIG. 2. An important aspect of the present invention is that the additional elements do not impact payment transactions that rely on the existing FIG. 1 financial transaction network architecture contained within the FIG. 2 financial transaction network architecture.

The FIG. 2 financial transaction network enables the purchase of goods and services from merchant 14 using the PSID associated with member identity token 36. Member identity token 36 is related to credit card 12 or any one of a set of credit cards by intermediate server 34 using the following process. Credit card issuing credit source 16, i.e., a bank, issues credit card 12 to a cardholder which contains a unique PSID that further contains the BIN associated with credit source 16. Sponsor 32 issues member identity token 36, i.e., member credit card, to the credit cardholder. Member identity token 36 has another unique PSID that contains the BIN associated with intermediate server 34.

The PSID of member identity token 36 is typically a 15 or 16 digit credit card number used within the American Express or VISA/Mastercard payment networks respectively. Although typically in credit card form, member identity token 36 may also be a smart card, cellular telephone, pager, personal digital assistant (PDA) or any other communications device with the ability to store, display, or transmit a PSID. Sponsor 32 may be any association, group, or organization to which the credit cardholder is a member such as a teacher's association, corporate customer group, auto association, or travel club. In certain applications, intermediate server 34 may also be directly associated with a credit source and member identity token 36 may be a credit card using the BIN of that credit source. Furthermore, intermediate server 34 could reside within, work in conjunction with, or be co-located with the IPP of a credit source.

After obtaining member identity token 36, the member cardholder provides the PSID of at least credit card 12 directly to intermediate server 34 or indirectly through sponsor 32. Intermediate server 34 then associates the PSID of member identity token 36 with the PSID of at least credit card 12. When the member presents the PSID associated with member identity token 36 to merchant 14 in order to purchase goods using credit provided by credit source 16, merchant 14 submits an associated payment transaction to MPP 18. During the purchase process, the merchant employee only observes the PSID of member identity token 36, not the PSID of credit card 12.

MPP 18 submits the payment transaction or TP to SPN 20 through access point 22. The payment transaction or TP may include the purchase amount, merchant 14 identifier, an access point 22 identifier, name of the cardholder, location of the purchase, CVV, expiration date, transaction number, and the PSID of member identity token 36 which further contains the BIN of intermediate server 34. SPN 20 routes the payment transaction, based on the BIN within the PSID, to access point 30, not access point 24.

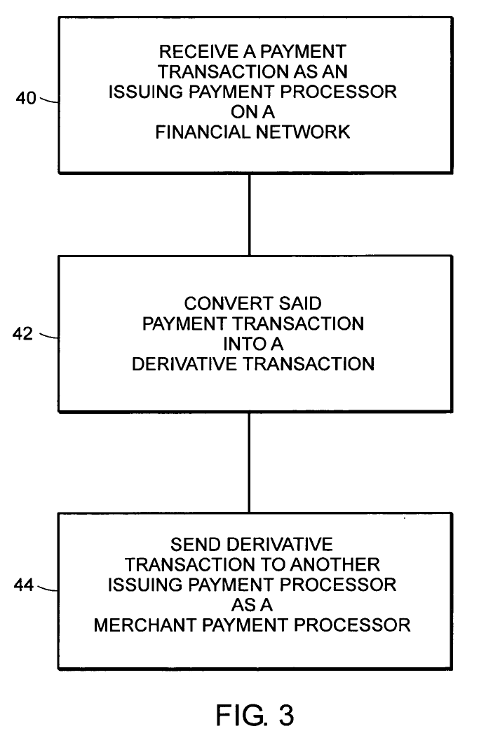

Instead of IPP 26 receiving the payment transaction, intermediate server 34, through access point 30, receives the payment transaction as an IPP (step 40, FIG. 3), converts the payment transaction into a derivative transaction (step 42), and then sends the derivative transaction, as a MPP, to IPP 46 (step 44).

In this instance, the derivative transaction may be identical to the original payment transaction except that the PSID associated with intermediate server 34 is replaced with the PSID associated with credit source 16 before intermediate server 34 sends the derivative transaction to IPP 26. Also, the source address of the payment transaction is now associated with access point 30 of intermediate server 34 instead of access point 22. A derivative transaction is any transaction created by intermediate server 34 in response to a payment transaction received from MPP 18 any other MPP. The derivative transaction, however, may be a completely new transaction.

Once IPP 26 receives the derivative payment transaction from access point 24, IPP 26 checks with credit source 16 that the derivative payment transaction is valid. Credit source 16 typically verifies that the available credit within the member's credit account is adequate to cover the amount in the received payment transaction and sends an approval code back to IPP 26. Once an approval code is received from credit source 16, IPP 26 sends the derivative payment transaction via access points 24 and 30 to intermediate server 34 with the approval code.

Intermediate server 34 then relays the derivative payment transaction and approval code to MPP 18 via access points 30 and 22. MPP 18 sends the transaction approval code to merchant 14, concluding the sale authorization. Capture and settlement may be immediately performed by intermediate server 34 to obtain the funds associated with the payment transaction from credit source 16. Also, capture and settlement may subsequently be performed, depending on the periodicity of the MPP 18 batch process, between MPP 18 and intermediate server 34 to transfer the cardholder finds associated with the payment transaction to merchant 14 account 192.

Intermediate server 34 may also flexibly capture and retrieve credit or monetary value from credit source 16 by accessing a standard, promotional, gift card, or discount account. For example, if the member obtains a virtual coupon or gift card for $50 dollars associated with a gift card account at credit source 16, intermediate server 34 may, instead of using the cardholder's credit source 16 standard account, automatically create a derivative transaction directed to the particular gift card account within credit source 16. Thus, gift cards or virtual coupons may be automatically used for a member by intermediate server 34. If the funds in the gift card account are not adequate to cover the full purchase amount, intermediate server 34 may initiate another derivative transaction to capture and retrieve the additional required funds from the cardholder's standard account.

It is important to note that credit source 16 may be any one of a set of credit sources associated with member identity token 36. Thus, intermediate server 34 may initiate another derivative transaction to capture and retrieve the additional required funds from any one or combination of accounts from any one of the credit sources in the set associated with member identity token 36.

Also, intermediate server 34 may use a derivative transaction to access a particular discount, merchant, or promotional account of credit source 16 that is associated with merchant 14 to enable merchant 14 to track the amount or type of promotional discounts used by certain customers. Furthermore, intermediate server 34 may create derivative transactions to automatically use virtual coupons, gift cards, or promotional accounts associated with any credit source including merchants, merchant accounts, banks, or governmental entities. Intermediate server 34 may initiate both a derivative authorization request and capture transaction, upon receipt of the approval code, to immediately acquire or settle the funds within a virtual coupon, gift card, or promotional account.

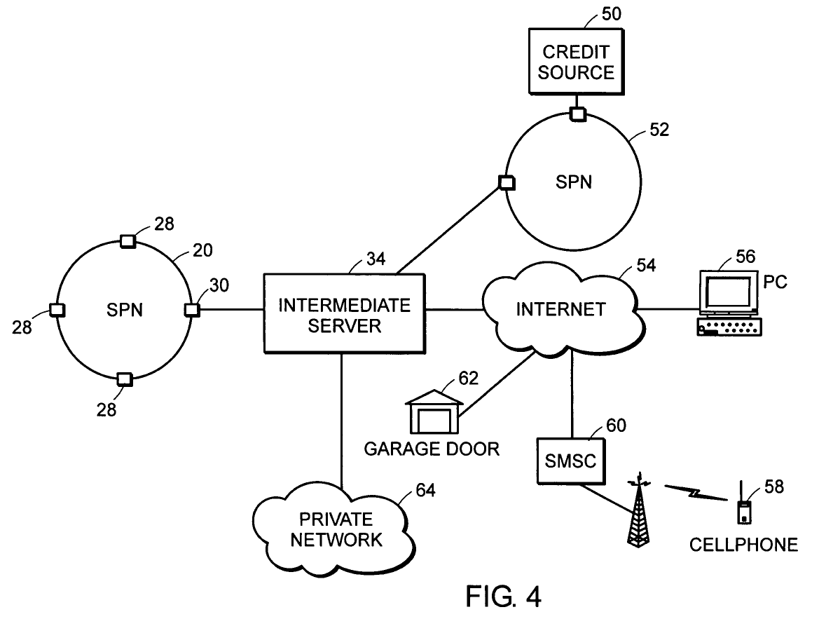

If the PSID of member identity token 36 is associated with FIG. 4 credit source 50 of SPN 52, a standard payment network that may not process payment transactions in a compatible manner with SPN 20, a second derivative transaction may be bridged by intermediate server 34 to SPN 52 in order to facilitate financial payment transactions between both financial networks. In other words, intermediate server 34 may act as a bridge between dissimilar networks such as the VISA/Mastercard and China financial transaction networks. Intermediate server 34 may use a bridging hardware unit or software application to convert an original payment transaction using the SPN 20 or SPN 52 format to the SPN 52 or SPN 20 payment transaction format, respectively.

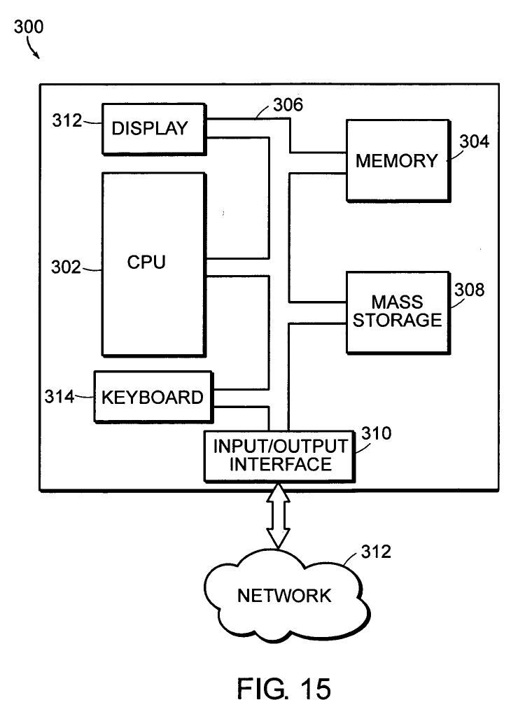

Also, a second derivative transaction may be bridged by intermediate server 34 to public network 54, e.g., the Internet, in order to trigger a non-financial action such as an e-mail alert to personal computer 56, a transaction notification to cellular telephone 58 via Short Message Service Center (SMSC) 60, or control message to dwelling 62 that opens a garage door. Furthermore, the second derivative transaction could also be bridged to private network 64, e.g., Signaling System Seven (SS7) network. All intermediate server 34 hardware and/or software processing may be performed using one general purpose computer server or multiple general purpose computer servers. A detailed description of the general purpose computer system is provided later with regard to FIG. 15.

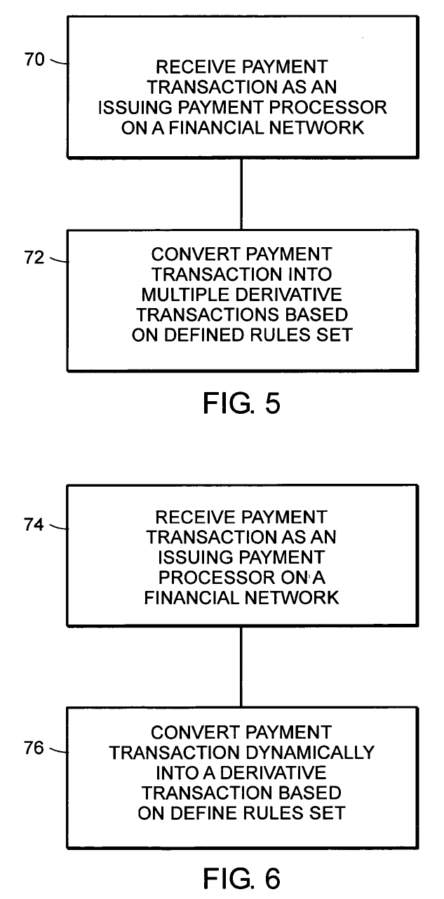

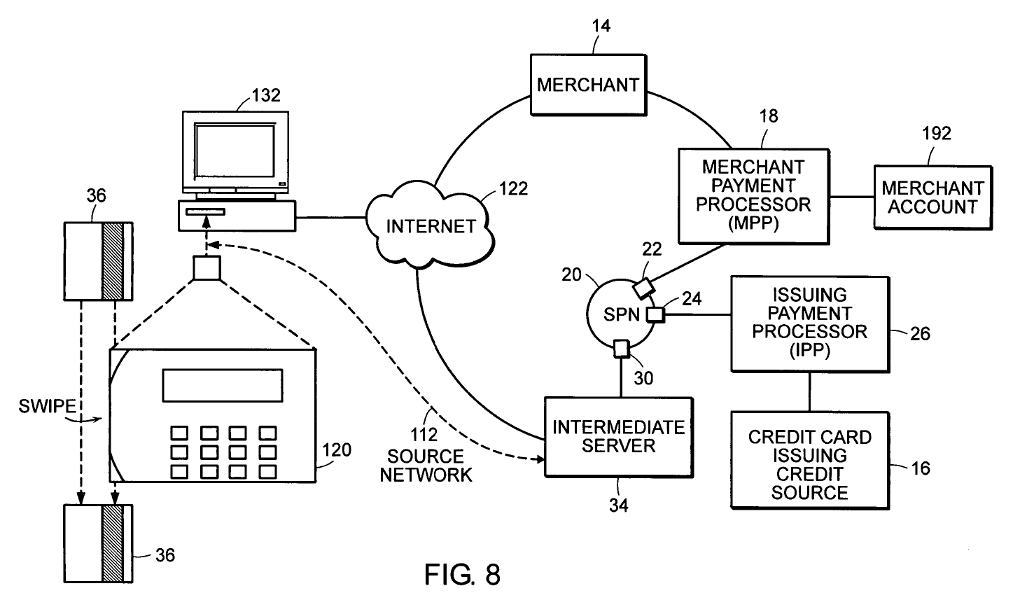

In another embodiment, a method and system of processing financial transactions on a financial network involves intermediate server 34 receiving a payment transaction as an IPP (step 70, FIG. 5) and converting the payment transaction (step 72) into multiple derivative transactions based on the FIG. 7 defined rules set 100. At least one of the derivative transactions may be sent to IPP 46 or to another IPP.

The defined rules set 100, as shown in FIG. 7, may be based on, but not limited to, preferences specified by various input entities such as the member token issuer, credit card issuer, member, merchant, and network. The preferences may specify limitations on the creation of derivative transactions based on date, time, purchase amount, purchase type, credit source sequence, merchant type, or location. Additional preferences may be supported.

For example, a merchant restaurant chain may provide a 10% promotional discount if the member has dinner before 6 p.m. at certain restaurant locations, but only with VISA credit cards. As shown in FIG. 2 and FIG. 7, when a payment transaction is received by intermediate server 34, intermediate server 34 compares the merchant 14 location and time information with unique rules set 100 associated with the member identity token 36 number, i.e., member identity token 36 PSID. If the purchase is before 6 p.m. at a participating restaurant location, intermediate server 34 creates a derivative payment transaction using the PSID of a VISA supported credit source. If the member has multiple VISA credit sources associated with member identity token 36, intermediate server 34 checks the member preferences for the member's preferred credit source sequence to determine which VISA credit source to use first.

Intermediate server 34 then automatically applies the 10% discount to the derivative payment transaction and sends the transaction to the selected VISA credit source. Intermediate server 34 may also create a new derivative collection transaction to capture and recover the 10% discount from a separate promotional account of merchant 14 to enable tracking of the number and location of discounts used by member customers. Intermediate server 34 may further create a derivative transaction that triggers an SMS message to the member's cellular telephone 58 of FIG. 4 which says “Thank you for dining at our Restaurant!” The number of derivative transactions generated by intermediate server 34 is potentially unlimited depending on the preferences defined in rules set 100.

Furthermore, the preferences of one rules set 100 input entity can be assigned higher priority over the preferences of other input entities. For example, if the member exceeds a credit limit specified in the VISA credit card issuer preferences when purchasing dinner from merchant 14, intermediate server 34 may automatically select the next VISA credit source with a sufficient credit limit to cover the purchase amount, effectively overriding the member's credit source sequence preference.

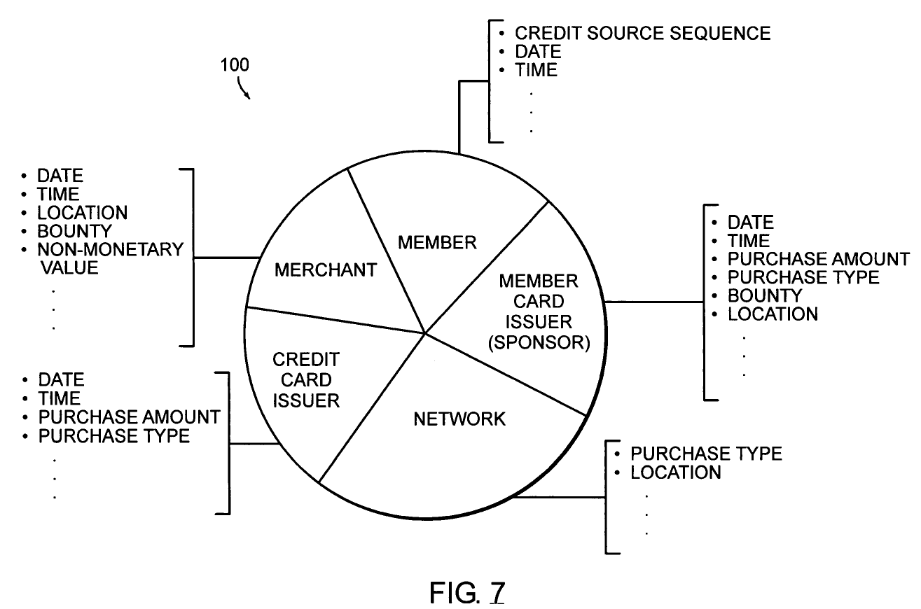

In another embodiment, as shown in FIG. 2, FIG. 6 and FIG. 7, a method of processing financial transactions on a financial network includes intermediate server 34 receiving a payment transaction as an IPP (step 74) and converting the payment transaction into a dynamically determined derivative transaction based on defined rules set 100 (step 76). The derivative transaction may then be sent to IPP 26, another IPP, another financial network, or another non-financial network. The important distinction with this embodiment is that intermediate server 34 can dynamically convert the same type of payment transaction into different derivative transactions based on defined rules set 100.

For example, as shown in FIG. 2 and FIG. 7, if merchant 14 provides a one-time 50% discount to Sponsor 32 members for concert tickets and defines a rule within rules set 100 for all members to enforce the one-time purchase, the discount is only applied by intermediate server 34 during the first purchase, resulting in a derivative payment transaction with the 50% discount. If a member attempts to make a second purchase of concert tickets, i.e., the same type of purchase, intermediate server 34, based on defined rules set 100, may create a derivative disapproval or “declined” transaction. If a member attempts to make a third purchase of the concert tickets, intermediate server 34 may then create a derivative payment transaction without the discount. Under each circumstance, the attempt to make the same financial transaction results in a different response from intermediate server 34 and a dynamically different derivative transaction.

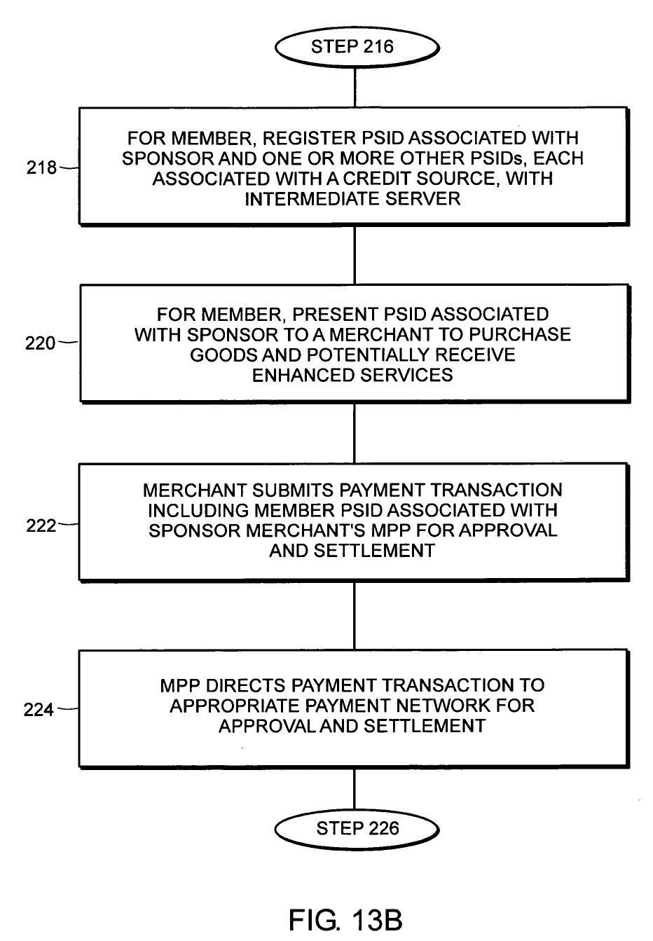

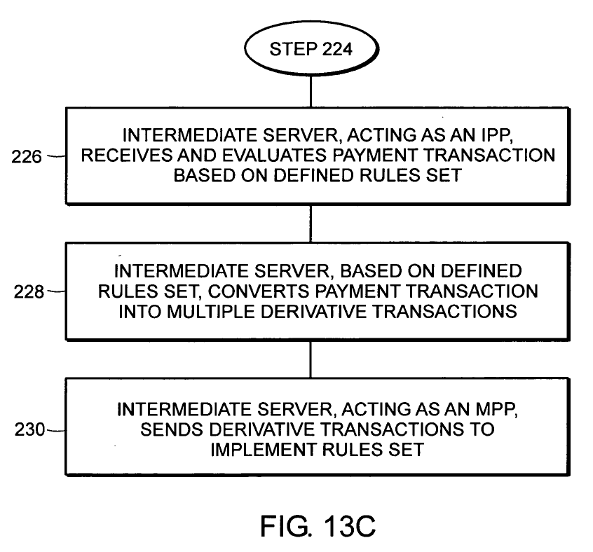

In another embodiment, as shown in FIG. 12, FIGS. 13A-C, and FIG. 7, a method of processing payments and promotional bounties using SPN 20 includes having sponsor 32 establish a rules set 100 regarding acceptance and use of member identity token 36. Sponsor 32 also defines portions of a merchant 14 bounty within rules set 100 to be shared among Sponsor 32, the member, and intermediate server 34 (step 210). A bounty is an amount of money that a merchant is willing to pay when a targeted customer or group of customers purchase goods or services. The merchant may be the selling merchant at the POS, the original manufacturer of the product purchased, a distributor of the product, or any entity within the product or service supply and distribution chain that uses a bounty to promote the purchase by a member. The bounty includes a discount to the member customer, a finder's fee for the association or sponsor that brings in the customer, and possible handling fee for an enabling entity such as intermediate server 34.

Sponsor 32 then recruits participating merchant 14 who establishes a bounty for any valid transaction using a member PSID associated with sponsor 32 (step 212). Merchant 14 establishes promotional fund source 172 and specifies the member discount associated with goods subject to the discount (step 214). Sponsor 32 issues member identity token 36 associated with a unique member PSID (step 216) to a member. The member then registers the PSID associated with sponsor 32 and one or more other PSIDs of credit cards such as credit card 12 issued by credit source 16 or associated with other credit sources, with intermediate server 34 (step 218).

To purchase goods and potentially receive enhanced services, the member presents the PSID associated with sponsor 32 to merchant 14 (step 220) who submits the payment authorization transaction, including member PSID associated with sponsor 32 to MPP 18 for approval and settlement (step 222). MPP 18 then directs the payment transaction to SPN 20 for approval and settlement via access point 22 (step 224).

Intermediate server 34, acting as an IPP, receives the payment transaction because it contains the intermediate server 34 BIN. Intermediate server 34 also evaluates the payment transaction using defined rules set 100 (step 226). Based on defined rules set 100, intermediate server 34 converts the payment transaction into multiple derivative transactions (step 228).

Then, intermediate server 34, acting as a MPP, sends the following derivative transactions via access point 30 to implement the rules set (step 230): a collection transaction to the member credit source 16 through access point 24 and IPP 26 for the amount associated with the purchased goods less any discount specified in defined rules set 100, a collection transaction to the merchant 14 promotional fund source 172 via access point 188 and IPP 190 for the bounty amount, a credit transaction to the merchant 14 account 192 via access point 22 and MPP 18 for the amount associated with the purchased goods, a credit transaction to sponsor 32 fund source 194 via access point 182 and IPP 196 in an amount equal to the portion of the bounty as defined by sponsor 32 within the rules set 100, i.e., the finder's fee, and a credit transaction to intermediate server 34 in an amount equal to the portion of bounty as defined by sponsor 32 within the rules set 100, i.e., handling fee. Intermediate server 34 also sends a transaction approval code to merchant 14 via access point 22 and MPP 18. Intermediate server 34 may optionally wait for the approval code from credit source 16 or immediately send an approval code in anticipation of credit source 16 approval.

To reduce the number of derivative transactions, intermediate server 34 may combine the above derivative collection and credit transactions with merchant 14 into one derivative credit transaction for the value of the purchased goods less the bounty and send such derivative transaction to merchant 14 account 192. The collection transactions may be further separated into derivative payment authorization and payment capture transactions. For example, after receiving the derivative payment authorization transaction from intermediate server 34 and determining that the member has sufficient funds, credit source 16 may send the transaction approval code to intermediate server 34 via access points 24 and 30. Intermediate server 34 may then immediately initiate a capture transaction to retrieve the funds from credit source 16.

Sponsor 32 may be the member card issuer defined in rules set 100 or an entity associated with the member card issuer. Credit source 16, sponsor fund source 194, and merchant promotional fund source 172 are typically banks or accounts within banks. Merchant account 192 is typically a business account controlled by an MPP and sanctioned by an acquiring bank. A member account may be activated when the member identity information is stored within intermediate server 34. Also, intermediate server 34 may reside on a data network using a ring topology such as the VISA payment transaction network. A credit source such as credit source 16 may be another merchant while merchant promotional fund source 172 is typically a bank account.

Because all entities are connected to SPN 20, all transactions typically occur in real-time or near real-time. Instead of immediately sending a derivative credit transaction to merchant 14, intermediate server 34 may only send the payment transaction approval code. In this instance, merchant 14 account 192 may not be settled for 24-72 hours until batch capture and settlement is completed between MPP 18 and intermediate server 34. The finder's and handler's fee may also be credited to sponsor 32 and intermediate server 34 respectively in real-time or near real-time.

Intermediate server 34, based on rules set 100, may increase the derivative credit transaction value according to the value of a virtual coupon, gift card, or promotional account residing at any credit source. Also, intermediate server 34 may collect non-monetary value from merchant 14, convert the non-monetary value to a monetary equivalent based on rules set 100, and use the resulting monetary value in derivative credit transactions. Such non-monetary value may be an amount of frequently flyer or loyalty points which may be stored in merchant database 200 and accessed using a derivative transaction via public network 198.

In another embodiment, the functionality of intermediate server 34 may be implemented within IPP 26 or intermediate server 34 may be co-located and interwork with IPP 26 and connect to access point 24. Furthermore, intermediate server 34 may be implemented as an enhanced IPP for a credit source or group of credit sources.

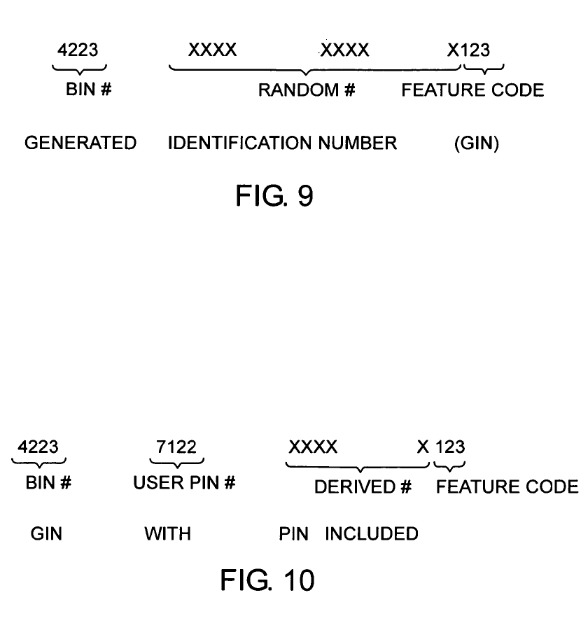

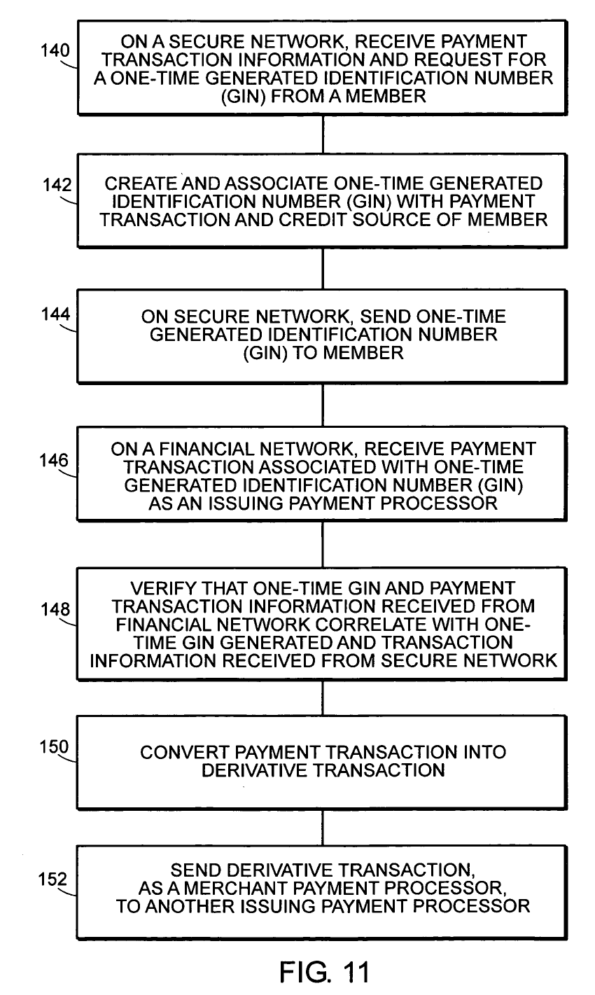

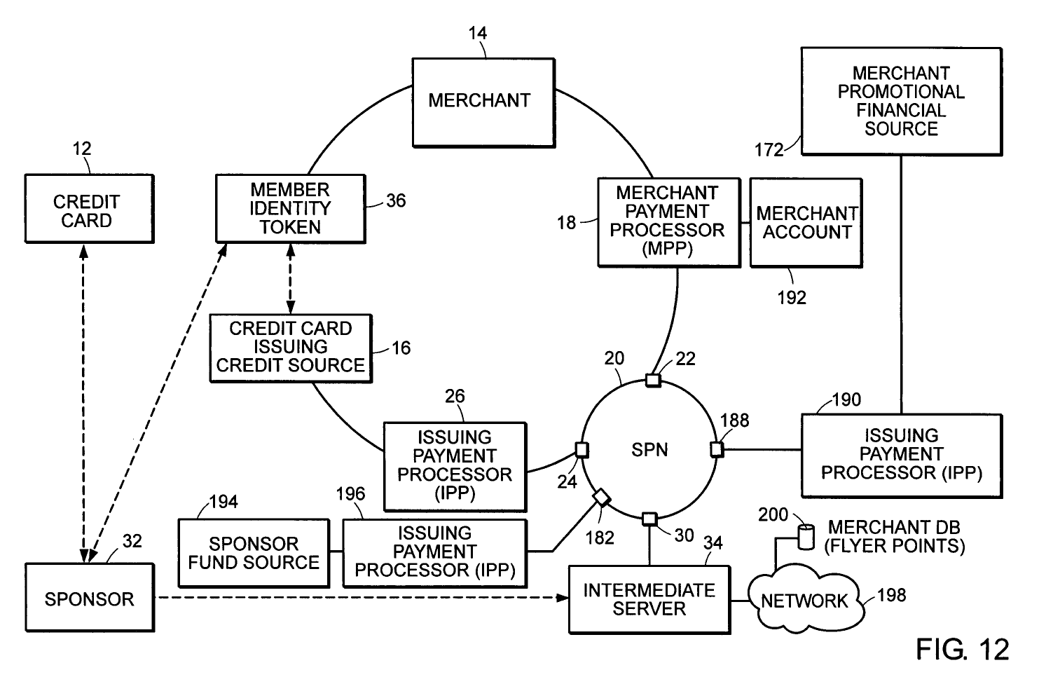

In yet another embodiment, the FIG. 8 financial transaction network provides enhanced financial transaction privacy and security by utilizing secure network 112 to deliver a Generated Identification Number (GIN), illustrated in FIGS. 9 and 10, from intermediate server 34 to POS terminal 120 that can subsequently be verified by intermediate server 34 in a payment transaction received from SPN 20. The GIN preferably has the same form as a member identity token 36 number or PSID, but is temporary or transient in nature. For example, a unique GIN may be associated with one or a limited number of payment transactions.

When a member performs a remote or on-line purchase of goods or services from merchant 14, the member swipes their member identity token 36, e.g., member credit card, through the magnetic stripe reader of POS terminal 120 and enters the purchase amount required from merchant 14 using the POS terminal 120 keypad. In this instance, POS terminal 120 is a terminal using the form factor of a personal computer floppy disk that also includes at least a LCD display, keypad, credit card reader, and personal computer floppy drive input/output data interface.

POS terminal 120 also supports either hardware or software applications that perform both authentication and encryption in order to establish secure network 112 with intermediate server 34. Other types of POS terminals may be used such as a merchant terminal, kiosk, wireless PDA, cellular telephone, personal computer, or any device capable of two-way communication with intermediate server 34. POS terminal 120 then sends the payment transaction information and GIN request via computer 132 and public network 122 within secure network 112 to intermediate server 34.

Secure network 112 may be a virtual private network (VPN) residing within or running above insecure public network 122, i.e., the Internet, or may use an encrypted and authenticated tunnel based on a shared secret between POS terminal 120 and intermediate server 34. Various forms of authentication may be supported such as SecureID, Public key Certificates, Secret key, Passwords, or Biometric authentication. The VPN for secure network 112 may use IPsec, Secure Sockets Layer (SSL), or any typical secure tunneling protocol. Various forms of public or symmetric key encryption may be used such as RSA, DES, Triple DES, IDEA, AES (Rijndael), or any other public or proprietary encryption algorithm.

Secure network 112, however, may not need cryptographic authentication and encryption if access is physically restricted to authorized users within a private network, i.e., a SS7 network. The security of secure network 112 is relative based on the requirements of members, merchants, and credit sources. Thus, complex data encoding, scrambling, or short key encryption to establish secure network 112 is adequate if it satisfies the secure network 112 user security requirements.

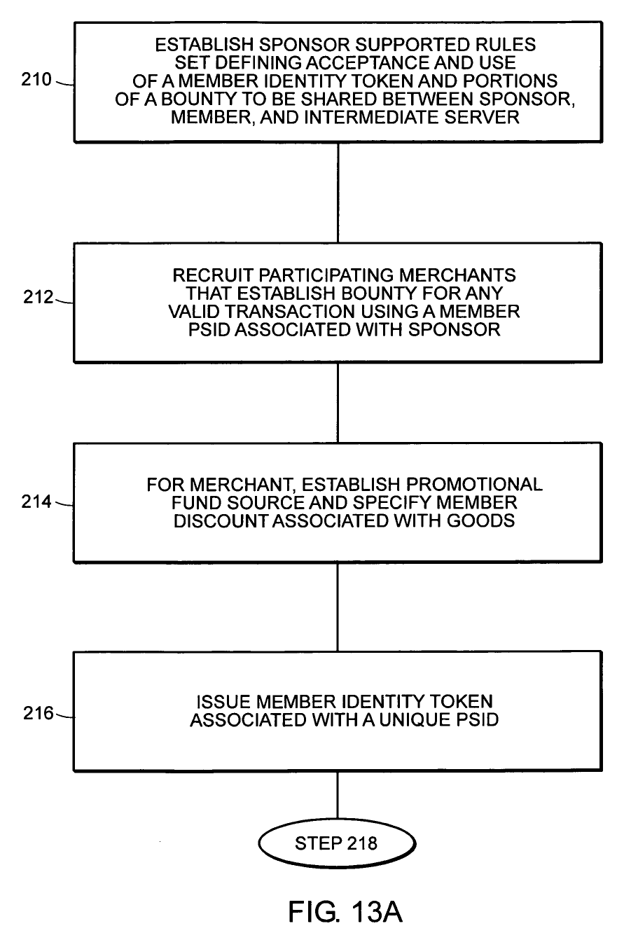

After Intermediate server 34 receives the payment transaction information and request for a GIN from the member through secure network 112 (step 140, FIG. 11), a GIN is created by intermediate server 34 and associated with the payment transaction and credit source 16 of the member (step 142). Then, the GIN is sent to the member through secure network 112 (step 144). The member submits the GIN in the PSID field, i.e., credit card number field, requested on the website order page, or any other type of electronic order form, of merchant 14 in order to make an on-line purchase. Merchant 14 then generates a payment transaction and sends the transaction to intermediate server 34 via access points 22 and 30 because the BIN within the GIN is that of intermediate server 34.

The payment transaction associated with the GIN is received by intermediate server 34, acting as an IPP on SPN 20 (step 146). The GIN and payment transaction information received from SPN 20 are then verified and correlated with the GIN generated and transaction information received from secure network 112 by intermediate server 34 (step 148). The payment transaction is then converted into a derivative transaction (step 150) using the PSID and BIN of a credit card associated with credit source 16. As discussed previously, intermediate server 34 may, based on a defined rules set, select any one of a number of credit sources associated with the member to direct the derivative transaction. Intermediate server 34, acting as a MPP, then sends the derivative transaction to IPP 26 (step 152) via access points 30 and 24.

After IPP 26 receives the derivative payment transaction from access point 24, IPP 26 verifies with credit source 16 that the derivative payment transaction is valid. Once an approval code is received from credit source 16, IPP 26 sends the derivative payment transaction via access points 24 and 30 to intermediate server 34 with the approval code. Intermediate server 34 then relays the derivative transaction with the approval code to MPP 18 via access points 30 and 22. MPP 18 sends the transaction approval code to merchant 14, concluding the on-line authorization and sale. Capture and settlement is performed as discussed in the previous embodiments.

The GIN is typically a one-time PSID as shown in FIG. 10 wherein a unique PSID is generated for each payment transaction only. Thus, intermediate server 34 associates that unique PSID with only one payment transaction. If a payment transaction using the one-time PSID has the wrong purchase amount, the transaction is discarded by intermediate server 34. The GIN effectively enables purchases in which the payment transaction can be bridged across an insecure network without compromising the security of the transaction or the privacy of the user making the transaction. In other words, even if the GIN and purchase amount are openly published, observers are not able to re-use the GIN again for future purchases or know who made the purchase because the GIN is only associated with one transaction.

At least a portion of the GIN may be randomly or pseudo-randomly generated, as shown in FIG. 10, or derived based on a combination of the BIN, date and time stamp of transaction initiation swipe, a terminal identification number, PSID, and a checksum as shown in FIG. 11. The GIN may be encoded with additional feature or authorization codes as shown in FIGS. 10 and 11. The feature or authorization code may additionally define transaction properties such as purchase limits, expiration date, accounts, usage constraints, and promotional access. The GIN typically uses the BIN associated with intermediate server 34 to enable routing of payment transactions to intermediate server 34. Furthermore, a member personal identification number (PIN) or secret may be included in the GIN, as shown in FIG. 11, or with the payment transaction information received from secure network 112.

By using secure network 112 to deliver the member PIN to intermediate server 34 and to create a GIN, CNP transactions may be converted to CP transactions which significantly reduces the interchange rate and cost of on-line transactions for merchant 14. It is possible, however, to use a long term PSID as the GIN or for a member to send a credit card PSID to intermediate server 34 within secure network 112 instead of using a GIN with a one-time PSID. In such a scenario, the credit cardholder can enjoy improved security because intermediate server 34 correlates the PSID with the transaction amount, time and location information. Furthermore, if the cardholder submits their PIN using secure network 112, the purchase may be converted by intermediate server 34 from a CNP to CP transaction.

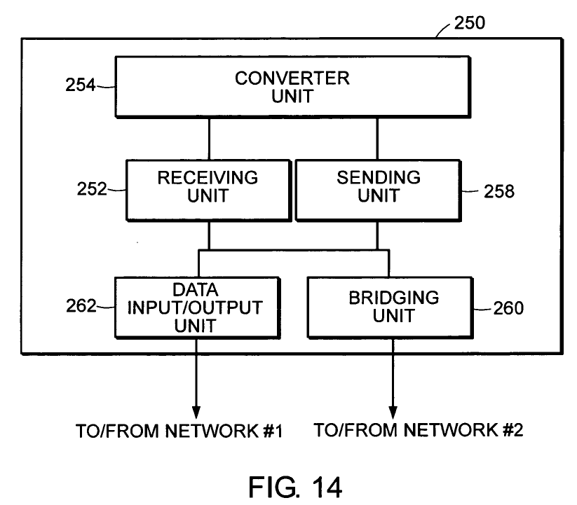

Another aspect of the embodiments features payment transaction processing system 250 of FIG. 14 that implements the processing of intermediate server 34 on SPN 20. Payment transaction system 250 utilizes receiving unit 252 that receives payment transactions as an IPP, converter unit 254 that determining the number and type of derivative transactions generated by intermediate server 34 based on the defined rules set 100 of FIG. 7, and sending unit 258 that sends derivative transactions as a MPP.

Furthermore, bridging unit 260 may be used to receive a payment transaction from SPN 72 of FIG. 4 and convert the payment transaction into an understandable format for receiving unit 252. Also, after receiving one or more derivative transactions from the sending unit 258, bridging unit 260 may convert the derivative transactions into an understandable format for SPN 72 and then send the derivative transactions to SPN 72. Additionally, system 250 may include data input/output unit 262 for sending and receiving data to and from SPN 20. SPN 20 may be the VISA payment transaction network while SPN 72 may be another type of financial transaction network such as the China financial transaction network.

All units of transaction processing system 250 may be implemented as software, firmware, or hardware units within a single general purpose computing system or each unit may be implemented within a separate computer system. Furthermore, one or more general purpose computers may implement the processing for any of the preceding financial transaction methods or systems.

FIG. 15 shows a functional block diagram of general purpose computer system 300, which may perform the functions of the intermediate server 34 of FIGS. 2, 4, 8, 12, and 14. The exemplary computer system 300 contains central processing unit (CPU) 302, memory 304, and interconnect bus 306. CPU 302 typically contains a single microprocessor, or may contain a plurality of microprocessors for configuring computer system 300 as a multi-processor system. The memory 304 includes a main memory, a read only memory, and mass storage devices such as various disk drives, tape drives, etc. The main memory typically includes dynamic random access memory (DRAM) and high-speed cache memory. In operation, the main memory stores at least portions of instructions and data for execution by the CPU 302.

The mass storage 308 may include one or more magnetic disk or tape drives or optical disk drives, for storing data and instructions for use by CPU 302. At least one component of mass storage system 308, preferably in the form of a disk drive or tape drive, stores the database used for processing financial transactions including PSIDs or GINs. Mass storage system 308 may also include one or more drives for various portable media, such as a floppy disk, a compact disc read only memory (CD-ROM), or an integrated circuit non-volatile memory adapter (i.e. PC-MCIA adapter) to input and output data and code to and from computer system 300.

Computer system 300 may also include one or more input/output interfaces for communications, shown by way of example as interface 310 for data communications via the network 312. Data interface 310 may be a modem, an Ethernet card or any other appropriate data communications device. To provide the functions of a intermediate server 34 according to FIG. 2, 4, 8, 12, or 14, data interface 310 preferably provides a relatively high-speed link to network 312 such as SPN 20 of FIG. 2. The physical communication link may be optical, wired, or wireless (e.g., via satellite or cellular network). Alternatively, computer system 300 may comprise a mainframe or other type of host computer system capable of web-based communications via network 312 such as used within the Internet.

Computer system 300 may further include appropriate input/output ports or use interconnect bus 306 for interconnection with local display 312 and keyboard 314 or the like serving as a local user interface for programming purposes. Alternatively, server operations personnel may interact with system 300 for control and programming of the system from remote terminal devices via network 312, e.g., the Internet or some other network link.

Computer system 300 may run a variety of application programs and store associated data in a database of mass storage system 308. One or more such applications may enable the receipt and delivery of messages to enable operation as the appropriate server, for implementation of server functions relating to financial transaction services such as defined rules set 100 of FIG. 7.

The components contained in computer system 300 are those typically found in general purpose computer systems used as servers, workstations, personal computers, network terminals, and the like. In fact, these components are intended to represent a broad category of such computer components that are well known in the art. Certain aspects of the invention may relate to the software elements, such as the executable code and database for the server functions of the financial transaction mechanisms and/or the client functions of POS terminal 120 of FIG. 8. The inventive concepts relate to methods, networks and systems (client and/or server) for implementing the financial transaction mechanisms.

Other aspects may relate to unique software products for implementing the inventive financial transaction mechanisms. A software product includes at least one computer or machine-readable medium and information carried by the medium. The information carried by the medium may be executable code, software, and one or more databases and/or information regarding the financial transaction methods and system.

A computer readable medium, as used herein, may be any physical element or carrier wave, which can bear instructions or code for performing a sequence of steps in a machine-readable form or associated data. Examples of physical forms of such media include floppy disks, flexible disks, hard disks, magnetic tape, any other magnetic medium, a CD-ROM, any other optical medium, a RAM, a ROM, a PROM, an EPROM, an EEPROM, a FLASH-EPROM, any other memory chip or cartridge, as well as media bearing the software in an understandable format.

A carrier wave type of medium is any type of signal that may carry digital information representative of the data or the instructions or code for performing the sequence of steps. Such a carrier wave may be received via a wireline or fiber-optic network, via a modem, or as a radio-frequency or infrared signal, or any other type of signal which a computer or the like may receive and decode.

At different times, all or portions of the executable code or database for any or all of these software elements may reside in physical media or be carried by electromagnetic media or be transported via a variety of different media to program the particular system. Physical media include the memory of computer processing system 300, such as various semiconductor memories, tape drives, disc drives and the like of general-purpose computer systems. All or portions of the software may at times be communicated through the Internet and/or various other telecommunication networks. Thus, another type of media that may bear the software elements includes optical, electrical and electromagnetic waves, such as used across physical interfaces between local devices, through wired and optical landline networks and over various air-links.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of processing financial transactions, the method comprising:
on a financial network, receiving a payment transaction as an Issuing Payment Processor;
converting said payment transaction into a derivative transaction; and
sending the derivative transaction, as a Merchant Payment Processor, to another Issuing Payment Processor.

2. The method according to claim 1 wherein a second derivative transaction is bridged to another payment processing network.

3. The method according to claim 1 wherein the second derivative transaction is a trigger for non-financial action.

4. The method according to claim 1 wherein, based on a defined rules set including member token issuer, credit card issuer, member, merchant, and network preferences, a dynamically determined derivative transaction is derived and sent to another Issuing Payment Processor;

5. The method according to claim 4 wherein preferences specify limitations on the creation of derivative transactions based on date, time, purchase amount, purchase type, or location.

6. The method according to claim 4 wherein preferences of one rules set input entity can be assigned higher priority over preferences of other input entities.

7. The method according to claim 1 wherein, based on a defined rules set including member token issuer, credit card issuer, member, merchant, and network preferences, multiple derivative transactions are derived and sent to other Issuing Payment Processors;

8. The method according to claim 1 wherein portions of a bounty are shared between a sponsor, member, and an intermediate server as specified by a defined rules set;

9. The method according to claim 1 wherein the derivative transaction is used to acquire monetary value derived from at least one of a virtual coupon, gift card, or promotional discount.

10. The method according to claim 1 wherein an Generated Identification Number (GIN) is used to associate a payment transaction to a member credit source.

11. The method according to claim 10 wherein the Generated Identification Number is a one-time Payment System Identifier.

12. The method according to claim 1 wherein a non-monetary value is converted to a monetary value.

13. The method according to claim 12 wherein a non-monetary value is frequent flyer points.

14. The method according to claim 1 wherein processing is performed by one or more general purpose computer systems.

15. A method of processing financial transactions, the method comprising:
on a financial network, receiving a payment transaction as an Issuing Payment Processor; and
converting said payment transaction into multiple derivative transactions based on a defined rules set.

16. The method according to claim 15 wherein at least one of the derivative transactions is sent to another Issuing Payment Processor.

17. The method according to claim 15 wherein the defined rules set is based on member token issuer, credit card issuer, member, merchant, and network preferences.

18. The method according to claim 17 wherein preferences specify limitations on the creation of derivative transactions based on date, time, purchase amount, purchase type, or location.

19. The method according to claim 17 wherein preferences of one rules set input entity can be assigned higher priority over preferences of other input entities.

20. The method according to claim 15 wherein, based on the defined rules set including member token issuer, credit card issuer, member, merchant, and network preferences, a dynamically determined derivative transaction is derived and sent to another Issuing Payment Processor;

21. The method according to claim 15 wherein portions of a bounty are shared between a sponsor, member, and an intermediate server as specified by the defined rules set;

22. The method according to claim 15 wherein the derivative transaction is used to acquire monetary value derived from at least one of a virtual coupon, gift card, or promotional discount.

23. The method according to claim 15 wherein processing is performed by one or more general purpose computer systems.

24. A method of processing financial transactions, the method comprising:
on a financial network, receiving a payment transaction as an Issuing Payment Processor; and
converting said payment transaction into a dynamically determined derivative transaction based on a defined rules set.

25. The method according to claim 24 further comprising sending said derivative transaction to another Issuing Payment Processor.

26. The method according to claim 24 wherein the defined rules set is based on member token issuer, credit card issuer, member, merchant, and network preferences.

27. The method according to claim 26 wherein preferences specify limitations on the creation of derivative transactions based on date, time, purchase amount, purchase type, or location.

28. The method according to claim 26 wherein preferences of one rules set input entity can be assigned higher priority over preferences of other input entities.

29. The method according to claim 24 wherein portions of a bounty are shared between a sponsor, member, and an intermediate server as specified by the defined rules set;

30. The method according to claim 24 wherein the derivative transaction is used to acquire monetary value derived from at least one of a virtual coupon, gift card, or promotional discount.

31. The method according to claim 24 wherein processing is performed by one or more general purpose computer systems.

32. A system for processing financial transactions using an intermediate server, the system comprising:
a receiving unit, acting as an Issuing Payment Processor on a financial network, that receives a payment transaction;
a converter unit that converts the payment transaction into a derivative transaction; and
a sending unit, acting as a Merchant Payment Processor, that sends the derivative transaction to another Issuing Payment Processor.

33. The system according to claim 32 wherein a second derivative transaction is bridged to another payment processing network.

34. The system according to claim 32 wherein a second derivative transaction is a trigger for non-financial action.

35. The system according to claim 32 wherein, based on a defined rules set including member token issuer, credit card issuer, member, merchant, and network preferences, the converter unit derives a dynamically determined derivative transaction and the sending unit sends said derivative transaction to another Issuing Payment Processor;

36. The system according to claim 35 wherein preferences specify limitations on the creation of derivative transactions based on date, time, purchase amount, purchase type, or location.

37. The system according to claim 35 wherein preferences of one rules set input entity can be assigned higher priority over preferences of other input entities.

38. The system according to claim 32 wherein, based on a defined rules set including member token issuer, credit card issuer, member, merchant, and network preference, the converter unit derives multiple derivative transactions and sending unit sends said derivative transactions to other Issuing Payment Processors;

39. The system according to claim 32 wherein portions of a bounty are shared between a sponsor, member, and an intermediate server as specified by a defined rules set;

40. The system according to claim 32 wherein the derivative transaction is used to acquire monetary value derived from at least one of a virtual coupon, gift card, or promotional discount.

41. The system according to claim 32 wherein an Generated Identification Number (GIN) is used to associate a payment transaction to a member credit source.

42. The system according to claim 32 wherein the Generated Identification Number is a one-time Payment System Identifier.

43. The system according to claim 32 wherein a non-monetary value is converted to a monetary value.

44. The system according to claim 43 wherein a non-monetary value is frequent flyer points.

45. The system according to claim 32 wherein processing is performed by one or more general purpose computer systems.

46. A system for processing financial transactions using an intermediate server, the system comprising:
a receiving unit, acting as an Issuing Payment Processor on a financial network, that receives a payment transaction; and
a converter unit that converts the payment transaction into multiple derivative transactions based on a defined rules set.

47. The system according to claim 46 further comprising a sending unit that sends at least one of the derivative transactions to another Issuing Payment Processor.

48. The system according to claim 46 wherein the defined rules set is based on member token issuer, credit card issuer, member, merchant, and network preferences.

49. The system according to claim 48 wherein preferences specify limitations on the creation of derivative transactions based on date, time, purchase amount, purchase type, or location.

50. The system according to claim 48 wherein preferences of one rules set input entity can be assigned higher priority over preferences of other input entities.

51. The system according to claim 46 wherein, based on the defined rules set including member token issuer, credit card issuer, member, merchant, and network preferences, the converter unit derives a dynamically determined derivative transaction and a sending unit sends said derivative transaction to another Issuing Payment Processor;

52. The system according to claim 46 wherein portions of a bounty are shared between a sponsor, member, and an intermediate server as specified by the defined rules set;

53. The system according to claim 46 wherein the derivative transaction is used to acquire monetary value derived from at least one of a virtual coupon, gift card, or promotional discount.

54. The system according to claim 46 wherein processing is performed by one or more general purpose computer systems.

55. A system of processing financial transactions using an intermediate server, the system comprising:
a receiving unit, acting as an Issuing Payment Processor on a financial network, that receives a payment transaction; and
a converter unit that converts the payment transaction into a dynamically determined derivative transaction based on a defined rules set.

56. The system according to claim 55 further comprising a sending unit that sends the derivative transaction to another Issuing Payment Processor.

57. The system according to claim 55 wherein the defined rules set is based on member token issuer, credit card issuer, member, merchant, and network preferences.

58. The system according to claim 57 wherein preferences specify limitations on the creation of derivative transactions based on date, time, purchase amount, purchase type, or location.

59. The system according to claim 57 wherein preferences of one rules set input entity can be assigned higher priority over preferences of other input entities.

60. The system according to claim 55 wherein portions of a bounty are shared between a sponsor, member, and an intermediate server as specified by the defined rules set;

61. The system according to claim 55 wherein the derivative transaction is used to acquire monetary value derived from at least one of a virtual coupon, gift card, or promotional discount.

62. The system according to claim 55 wherein processing is performed by one or more general purpose computer systems.

63. A method of processing payments and promotional bounties using a payment processing network, the method comprising:
A. establishing a sponsor supported rules set defining acceptance and use of a member identity token and portions of a bounty to be shared between the sponsor, member, and an intermediate server;
B. recruiting participating merchants that establish a bounty for any valid transaction using a member payment system identifier associated with the sponsor;
C. for a merchant, establishing promotional find source and specifying member discount associated with goods;
D. issuing a member identity token associated with a unique member payment system identifier;
E. for a member, registering a payment system identifier associated with the sponsor and one or more other payment system identifiers, each associated with a credit source, with the intermediate server;
F. for a member, presenting payment system identifier associated with the sponsor to a merchant to purchase goods and potentially receive enhanced services;
G. the merchant submitting payment transaction including member payment system identifier associated with the sponsor to the Merchant's Payment Processor for approval and settlement;
H. the Merchant Payment Processor directing the payment transaction to appropriate payment network for approval and settlement;
I. the intermediate server, acting as an Issuing Payment Processor, receiving and evaluating said payment transaction based on defined rules set;
J. the intermediate server, based on said defined rules set, converting said payment transaction into multiple derivative transactions; and
K. the intermediate server, acting as a Merchant Payment Processor, sending derivative transactions to implement the rules set.

64. The method according to claim 61 wherein the intermediate server performs the following derivative transactions to implement the rules set:
a derivative collection transaction to the member credit source for the amount associated with the purchased goods less the discount specified in the defined rules set;
derivative collection transaction to the merchant promotional fund source for the bounty amount;
derivative credit transaction to the merchant account for the amount associated with said purchased goods;
derivative credit transaction to the sponsor in an amount equal to the portion of bounty as defined by said sponsor within the rules set;
derivative credit transaction to the intermediate server in amount equal to the portion of bounty as defined by said sponsor within said rules set.

65. The method according to claim 63 wherein the payment system identifier is a credit card number.

66. The method according to claim 65 wherein the credit card number is 15 or 16 digits in length.

67. The method according to claim 63 wherein the member identity token is a credit card.

68. The method according to claim 63 wherein the member identity token is a smart card.

69. The method according to claim 63 wherein the member identity token is a cellular telephone.

70. The method according to claim 63 wherein the member identity token is a pager or personal digital assistant (PDA).

71. The method according to claim 63 wherein said credit source is at least one of a standard, gift card, or promotional bank account.

72. The method according to claim 63 wherein member account is activated when member identity information is stored within the intermediate server.

73. The method according to claim 63 wherein the intermediate server resides on a data network using a ring topology.

74. The method according to claim 63 wherein all transactions occur in real-time or near real-time.

75. The method according to claim 63 wherein the credit source is another merchant.

76. The method according to claim 63 wherein the promotional fund source is a bank account.

77. The method according to claim 63 wherein the intermediate server, based on the rules set, may increase the derivative credit transaction value according to the value of at least one of a virtual coupon, gift card, or promotional discount.

78. The method according to claim 63 wherein the intermediate server collects non-monetary value from said merchant, converts non-monetary value to a monetary equivalent based on the rules set, and uses resulting monetary value in derivative credit transactions.

79. The method according to claim 78 wherein the non-monetary value is an amount of frequently flyer points.

80. The method according to claim 63 wherein processing is performed by one or more general purpose computer systems.

81. A method of processing financial transactions with enhanced privacy and security, the method comprising:
on a secure network, receiving payment transaction information and request for a Generated Identification Number (GIN) from a member;
creating and associating said Generated Identification Number (GIN) with said payment transaction and a credit source of said member;
on said secure network, sending Generated Identification Number (GIN) to said member;
on a financial network, receiving said payment transaction associated with said Generated Identification Number (GIN) as an Issuing Payment Processor;
verifying that Generated Identification Number (GIN) and payment transaction information received from said financial network correlate with Generated Identification Number (GIN) generated and transaction information received from said secure network;
converting said payment transaction into a derivative transaction; and
sending the derivative transaction, as a Merchant Payment Processor, to another Issuing Payment Processor.

82. The method according to claim 81 wherein the Generated Identification Number (GIN) is a one-time payment system identifier (PSID).

83. The method according to claim 81 wherein a member personal identification number (PIN) or secret is included in the Generated Identification Number (GIN) or with the payment transaction information received from the secure network.

84. The method according to claim 81 wherein at least a portion of the Generated Identification Number (GIN) is randomly or pseudo-randomly generated.

85. The method according to claim 81 wherein at least a portion of the Generated Identification Number (GIN) is derived based on a combination of a bank identification number, date and time stamp of transaction initiation swipe, a terminal identification number, payment system identifier, and a checksum.

86. The method according to claim 81 wherein the Generated Identification Number (GIN) is encoded with additional feature or authorization codes.

87. The method according to claim 81 wherein a Bank Identification Number (BIN) is included in the Generated Identification Number (GIN).

88. The method according to claim 81 wherein said secure network is a virtual private network within a insecure network.

89. The method according to claim 81 wherein processing is performed by a general purpose computer server or multiple general purpose computer servers.

90. The method according to claim 81 wherein said secure network uses an encrypted and authenticated tunnel based on a shared secret between a member point-of-sale terminal and a general purpose computer server.

91. The method according to claim 90 wherein said point-of-sale terminal has the form factor of and may be inserted as any one of a floppy disk and universal serial bus device into a personal computer.

92. A system for processing financial transactions using an intermediate server, the system comprising:
receiving means for receiving payment transactions as an Issuing Payment Processor;
converter means for determining the number and type of derivative transactions based on a defined rules set and converting the original payment transaction into said derivative transactions;
sending means for sending one or more derivative transactions as a Merchant Payment Processor;

93. The system according to claim 92 further comprising a bridging means for receiving a payment transaction from a second network, converting said payment transaction into an understandable format for said receiving means or, after receiving one or more derivative transactions from the sending means, converting said derivative transactions into an understandable format for said second network and sending said derivative transactions to said second network.

94. The system according to claim 92 further comprising a data input/output means for sending and receiving data to and from said financial network.

95. The system according to claim 92 wherein system processing is performed by one or more general purpose computer systems.

96. A system for processing financial transactions using an intermediate server, the system comprising:
a receiving means for receiving a payment transaction as an Issuing Payment Processor on a financial network; and
a converter means for converting the payment transaction into multiple derivative transactions based on a defined rules set.

97. A system for processing financial transactions using an intermediate server, the system comprising:
a receiving means for receiving a payment transaction as an Issuing Payment Processor on a financial network; and
a converter means for converting the payment transaction into a dynamically determined derivative transaction based on a defined rules set.
